(19) United States
(12) Patent Application Publication
(10) Pub. No.: US 2009/0008963 A1
(43) Pub. Date: Jan. 8, 2009

(54) Energy absorbing element for multiple unit vehicles

(75) Inventor: Harald Lindner, Salzgitter (DE)

Correspondence Address: AKERMAN SENTERFITT, 801 PENNSYLVANIA AVENUE N.W., SUITE 600, WASHINGTON, DC, 20004, US

(73) Assignee: Voith Patent GmbH, Heidenheim (DE)

(21) Appl. No.: 12/149,786

(22) Filed: May 8, 2008

(30) Foreign Application Priority Data
May 8, 2007 (EP) 07 107 702.8

(51) Int. Cl. B60R 27/00

(52) U.S. Cl. 296/187.03

(57) ABSTRACT

The present invention relates to an energy dissipation device, for example for a coupling assembly, having a bearing block (2, 3) comprising an interface (4), by means of which impact forces can be conducted to the bearing block (2, 3), and a deformation tube (5), wherein the bearing block (2, 3) comprises a first bearing support part (2) fixedly mountable to a car body (2) and a second bearing support part (3) connected to the interface (4), and wherein the deformation tube (5) comprises a section (5.1) fixedly connected to the first bearing support part (2) at its coupling plane-side end section (5b) which exhibits a widened cross-sectional area compared to a deformation tube section (5.2) disposed closer to the car body. So that in the event of a crash, the second bearing support part (3) can move toward the car body relative the first bearing support part and the deformation tube (5) with simultaneous cross-sectional widening of said deformation tube (5) without the deformation tube (5) canting in the process, the invention provides for the bearing block to further comprise a guide element (6), its coupling plane-side end section (6b) connected to the car body-side end section (3a) of the second bearing support part (3) and its car body-side end (6a) extending at least partly into the deformation tube section (5.2) disposed closer to the car body and abutting against the inner surface of said deformation tube section (5.2).

The present invention relates to an energy dissipation device for a coupling assembly, for a close coupler or for a side buffer of a multi-member vehicle, having a bearing block mountable to a car body which comprises an interface preferably oriented to the coupling plane by means of which the impact forces transmitted from an adjacent car body can be conducted to the bearing block, and a deformation tube positioned against the bearing block, wherein the bearing block comprises a first bearing support part fixedly mountable to a car body of the multi-member vehicle and a second bearing support part connected to the car body-side end section of the interface, wherein the deformation tube comprises a section fixedly connected to the first bearing support part at its coupling plane-side end section which exhibits a widened cross-section compared to a section of the deformation tube located closer to the car body, and wherein the car body-side end section of the second bearing support part is braced between the first bearing support part and the section of the deformation tube positioned closer to the car body.

The principle behind an energy dissipation device of this type is known from the prior art, being employed for example in rail vehicle technology as a shock absorber for a coupling assembly. Such a shock absorber usually consists of a combination of a drawgear (spring device) and an energy dissipation device in the form of a deformation tube, whereby the energy dissipation device of the shock absorber protects the vehicle, particularly also at high impact speeds. It is thereby for example provided for the drawgear to absorb tractive and impact forces up to a defined magnitude and then route forces in excess thereof to the undercarriage of the vehicle.

By so doing, while the tractive and impact forces which occur during the normal operation of the vehicle, for example between the individual car bodies of a multi-member vehicle, will be absorbed by the usually regeneratively-designed drawgear of the shock absorber, upon the operating load of the drawgear being exceeded, for instance should the vehicle collide with an obstacle or be subject to abrupt braking, the regeneratively-designed drawgear and any coupling connection which may be provided between the individual car bodies may possibly be destroyed or damaged. In any case, the drawgear of the shock absorber cannot absorb all of the resultant energy. Such a drawgear is then no longer incorporated in the energy dissipation concept of the vehicle as a whole, so that the resultant impact energy is transmitted directly to the vehicle undercarriage. The latter is thus subjected to extreme forces and may possibly be damaged or even destroyed. In the case of rail vehicles, there is also the danger of the car bodies derailing.

In order to protect the vehicle undercarriage against damage upon violent collisions, shock absorbers are thus frequently equipped with a destructively-configured or regeneratively-configured energy dissipation device which is designed, for example, to respond after the drawgear's effective absorption has been fully tapped and thus at least partly absorb and thus dispel the energy transmitted in the force flow through the energy dissipation device. Particularly applicable energy dissipation devices are those which comprise a deformation tube. Such energy dissipation devices destructively convert impact energy into work of deformation and heat by the defined plastic deformation of an element (deformation tube).

It is hereto known from the state of rail vehicle technology to e.g. connect the car body-side end section of the coupling rod to a bearing block so as to be pivotable in the horizontal plane, whereby the usually regeneratively-designed drawgear, which is to absorb and thus cushion the forces occurring during normal vehicle operation and shunting, is disposed either in the coupling rod itself or in the articulation of the coupling rod to the bearing block. An energy-dissipating element in the form of a deformation tube disposed downstream of the bearing block and of preferably destructive design is for example utilized as the energy dissipation device. This energy-dissipating element, configured for example in the form of a deformation element, serves to dissipate the impact energy occurring upon the operating load of the coupling assembly being exceeded by means of work of deformation. The energy dissipation device is hereto designed to respond once a given amount of energy transmitted in the force flow through the deformation tube is exceeded and absorb at least a portion of the energy transmitted from the coupling rod and the coupling assembly. After this response of the energy dissipation device, the deformation element needs to be commensurately replaced.

As described for example in the DE 4 302 444 A1 printed publication, the deformation element utilized as the energy-dissipating element can consist for example of a deformation tube, its car body-side end section being of conical configuration and extending into a correspondingly conical bore configured in a nozzle plate. In this known central buffer coupling, the bearing block connected to the drawgear via the coupling rod, for example by means of screws, the deformation tube, the nozzle plate and an anchor plate on the undercarriage of the rail vehicle which allows the passage of the deflected deformation tube subsequent to or during the response of the energy dissipation device, are axially braced to one another.

Thus proposed as an energy-dissipating element in the coupling assembly known from the DE 4 302 444 A1 printed publication is a deformation tube positioned against the bearing block of the coupling assembly and designed to be pressed by the nozzle plate abutting the car body-side end section of the deformation tube, undergoing narrowing of its cross-sectional area, via an axial displacement of the bearing block and the deformation tube relative to the undercarriage of the car body upon the operating load of the coupling assembly being exceeded.

The disadvantage of this solution can firstly be seen in that a relatively large space is required for the backward movement of the bearing block together with the deformation tube into the undercarriage of the car body, since when the deformation tube deflects, i.e. when the energy dissipation device responds, the deformation tube is pressed by the nozzle plate into a space needing to be additionally provided behind the coupling assembly. In coupling assemblies in which this additional space is not provided, for example due to the direct proximity to a bogie, it will not be possible to realize this known prior art solution as the energy dissipation device for protecting the coupling assembly in the event of a crash.

Secondly, with the solution known from the DE 4 302 444 A1 printed publication, there is the risk that when the energy dissipation device responds—in particular upon vertical or oblique, i.e. not entirely axial impact on the deformation tube—the deformation tube will have a tendency to “jam” or wedge in the conical bore configured in the nozzle plate for example, so that the function of destructive energy dissipation is no longer reliably provided.

Also already known from rail vehicle technology as an energy-dissipating element is for example a deformation tube which does not plastically deform via narrowing of its cross-sectional area upon the energy dissipation device being actuated but rather via widening of its cross-sectional area so that in a crash, the deflected deformation tube is prevented from being ejected from the energy dissipation device. This solution thus already provides for realizing an energy dissipation device of maximum energy dissipation coupled with a small installation space.

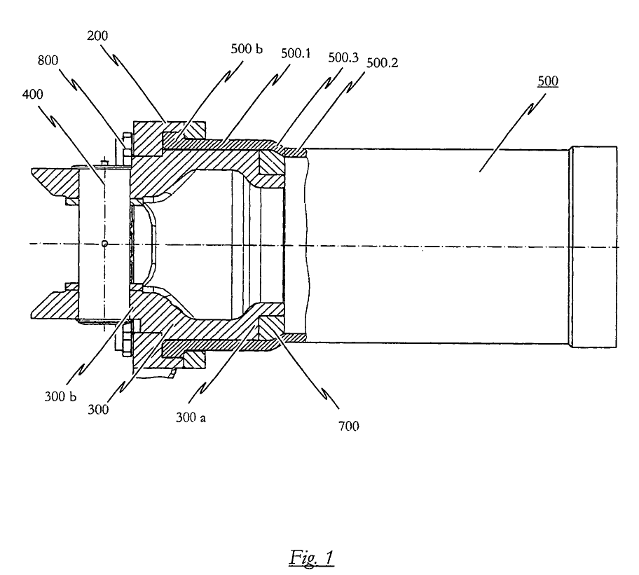

This type of solution for an energy dissipation device utilized in a coupling assembly is depicted for example schematically in FIG. 1. In detail, FIG. 1 shows a partly sectional representation of a bearing block as generally known in the prior art, with a deformation tube abutting its car body-side end section forming the energy-dissipating element and which is designed to plastically deform by widening of its cross-sectional area upon axial displacement of the bearing block toward the car body once the operating load of the coupling assembly has been exceeded.

The bearing block depicted in FIG. 1 specifically comprises a vertically-extending pivot pin 400, by means of which a car body-side end section of a coupling rod, not explicitly shown in FIG. 1, is articulated to the bearing block so as to be pivotable in the horizontal plane. The bearing block consists of a first bearing support part 200 fixedly attachable to a (not explicitly shown) car body and a second bearing support part 300 connectable to the car body-side end section of the coupling rod by means of the pivot pin 400. Specifically, the car body-side end section of the coupling rod is pivotably coupled to the coupling rod-side or coupling plane-side end section 300b of the second bearing support part 300 by means of the pivot pin 400.

The deformation tube 500, which positions against the bearing block in the solution as depicted in FIG. 1 and known from the prior art, exhibits a section 500.1 on its coupling plane-side end section 500b fixedly connected to the first bearing support part 200. This deformation tube section 500.1 fixedly connected to the first bearing support part 200 has a widened cross-sectional area compared to the deformation tube section 500.2 disposed closer to the car body.

In the solution depicted in FIG. 1, a conical ring 700 is further provided, which is fixedly connected to the car body-side end section 300a of the second bearing support part 300 on its coupling rod-side or coupling plane-side end section, whereby its car body-side end section abuts against the inner surface of the transition section 500.3 between deformation tube section 500.1 with the widened cross-section and deformation tube section 500.2 situated closer to the car body. In so doing, the second bearing support part 300 with its car body-side end section 300a is braced between the first bearing support part 200 and the deformation tube section 500.2 disposed closer to the car body.

In the event of a crash; i.e. when excessive impact is transmitted through the coupling assembly, and when this excessive impact effects a deformation of deformation tube 500, the second bearing support part 300 with the conical ring 700 displaces in the direction of the car body relative the first bearing support part 200 fixedly attached to the car body and the deformation tube 500, whereby the deformation tube section 500.2 disposed closer to the car body undergoes a widening of its cross-sectional area by plastic deformation.

As with the solution described above in conjunction with the DE 4 302 444 A1 printed publication, the realization of an energy dissipation device as depicted in FIG. 1 also entails the fundamental risk that those components which displace toward the car body relative to the first bearing support part fixedly mounted to the car body during a crash will cant upon this axial displacement, whereby the achievable energy dissipation will be indeterminate and in particular not yield a predeterminable sequence of events in the dissipation of energy. Specifically, there is the fundamental risk with the solution depicted in FIG. 1 and generally known in the prior art that during the axial displacement toward the car body, the second bearing support part 300 with the conical ring 700 provided on the car body-side end section 300a of the second bearing support part 300 will cant or wedge inside deformation tube 500. With the solution described in conjunction with DE 4 302 444 A1, there is the danger that in the event of a crash, the deformation tube itself, which in this solution is axially displaced toward the car body together with the second bearing support part, will wedge or jam in the opening provided in the nozzle plate.

Based on this problem as set forth, the present invention now addresses the task of further advancing an energy dissipation device of the type cited at the outset and as utilized as a shock absorber in the coupling assembly as described for example above with reference to FIG. 1 so as to realize maximum energy dissipation coupled with a predeterminable sequence of events upon a crash. In particular, an energy dissipation device is to be specified with which in the event of a crash; i.e. for example upon the operating load of the coupling assembly being exceeded, at least a portion of the resultant impact energy can be dissipated according to a defined and predeterminable sequence of events on the one hand and, on the other, the energy-dissipating element employed thereto requires the smallest possible installation space in the undercarriage of the car body.

This task is solved with an energy dissipation device of the type cited at the outset in that the bearing block inventively further comprises a guide element, its coupling plane-side end section connected to the car body-side end section of the second bearing support part, and its car body-side end section extending at least partly into the section of the deformation tube disposed closer to the car body and being positioned against the inner surface of said deformation tube section.

The advantages achievable with the proposed solution are obvious. Firstly, furnishing a deformation tube downstream of the bearing block and designed to plastically deform by cross-sectional widening upon for example the operating load of the coupling assembly being exceeded, provides an energy dissipation device yielding maximum energy dissipation at the smallest possible installation space. This is achieved as such since upon the energy dissipation device responding, the deformation tube is not expelled from a space additionally provided e.g. in the undercarriage of the car body.

On the other hand, by the proposed solution providing for a guide element, a predeterminable sequence of events in the process of energy dissipation is also possible in the event of a crash. Said guide element, which is connected by its coupling plane-side end section to the second bearing support part, thereby extends with its car body-side end section at least partly into the deformation tube section, its cross-section prior to the response of the energy dissipation device unwidened compared to the widened cross-section of the coupling plane-side end section of the deformation tube. Since, on the one hand, the guide element abuts against the inner surface of the unwidened deformation tube section prior to the energy dissipation device responding and since, on the other hand, the coupling plane-side end section of the guide element is connected to the car body-side end section of the second bearing support part, the car body-side end section of the guide element runs along the inner surface of the not (yet) widened deformation tube section upon response of the energy dissipation device; i.e. when the second bearing support part with the guide element is moved toward the car body relative to the fixedly-mounted first bearing support part on the car body and the deformation tube fixedly connected to the first bearing support part, and thus effects an axial guidance of the second bearing support part. This axial guidance of the second bearing support part prevents a canting of the second bearing support part in the deformation tube upon response of the energy dissipation device so that the plastic deformation of the deformation tube (i.e. the plastic cross-sectional widening of the deformation tube) proceeds in a predictable manner and the sequence of events of energy dissipation during a crash is as a whole predictable.

Advantageous embodiments of the inventive solution, in particular as related to realizing the energy dissipation device, are set forth in the subclaims.

It is thus provided in a particularly preferred realization of the solution according to the invention for the guide element of the bearing block to comprise a conical ring preferably integrally formed with the guide element, its coupling plane-side end section connected to the car body-side end section of the second bearing support part and its car body-side end section extending at least partly into the section of the deformation tube disposed closer to the car body and abutting the inner surface of this deformation tube section, its cross-section not yet widened prior to the energy dissipation device being actuated. In this preferred realization, the guide element thus assumes the axial guidance of the second bearing support part upon response of the energy dissipation device on the one hand and, on the other, the function of the conical ring. The coupling plane-side section of the guide element thereby abuts the transition section between the widened deformation tube section and the deformation tube section with the still unwidened cross-section in comparison to the widened cross-section of the coupling plane-side end section of the deformation tube prior to the response of the energy dissipation device, and effects the plastic expansion of the as-of-yet unwidened deformation tube section upon actuation of the energy dissipation device when the second bearing support part together with the guide element is displaced toward the car body relative the deformation tube. Since the car body-side section of the guide element basically abuts against the inner surface of the deformation tube section with the reduced cross-sectional area compared to the coupling plane-side end section of the deformation tube with the widened cross-sectional area, the necessary axial guidance of the second bearing support part is effected by this guide element section upon the response of the energy dissipation device.

The latter cited preferred realization of the guide element comprising a conical ring preferably integrally formed with said guide element provides for the coupling plane-side end section of the guide element (respectively the coupling plane-side end section of the conical ring) to be positively engaged with the car body-side end section of the second bearing support part. Opting for a positive connection between the car body-side end section of the second bearing support part and the coupling plane-side end section of the guide element enables a reliable and defined transmission of force from the second bearing support part to the guide element, in particular upon the energy dissipation device being actuated. Upon the energy dissipation device being actuated, the force conducted to the guide element from the section of the guide element configured as a conical ring and abutting the transition section between the already-widened deformation tube section and the not (yet) widened deformation tube section is used to plastically deform the originally unwidened deformation tube section.

Particularly by providing a conical ring, conical ring section respectively, in the transition section between the already-widened deformation tube section and the not (yet) widened deformation tube section, an especially high and ideally full transmission of force can be realized from the second bearing support part to the transition section of the deformation tube, whereby the response time and response behavior of the energy dissipation device on the one hand and the sequence of events during energy dissipation, i.e. after the energy dissipation device has responded, on the other, can be precisely predefined.

Additionally or alternatively to the latter cited preferred embodiment related to the connection between the coupling plane-side end section of the guide element, conical ring respectively, and the car body-side end section of the second bearing support part in the form of a positive engagement, it is however also conceivable to realize a positive or force-fit connection or an entirely force-fit connection, for example by means of a bolted joint. Particularly preferred is for the coupling plane-side end section of the guide element to basically be coupled to the car body-side end section of the second bearing support part as free of play as possible so as to shorten, respectively precisely predetermine and define, the response time and the response behavior of the energy dissipation device upon a crash.

Because in the above-cited preferred realization of the guide element, which comprises a conical ring preferably integrally formed with the guide element, the section of the guide element which assumes the function of a conical ring and abuts against the inner surface of the transition section between the deformation tube section with the widened cross-sectional area and the deformation tube section disposed closer to the car body of cross-sectional area not (yet) widened by plastic deformation, the most defined and full transmission of force possible is enabled through the deformation tube from the second bearing support part to the first bearing support part at the transition section of the deformation tube between the section with the widened cross-sectional area and the section with the not (yet) widened cross-sectional area, which yields particularly precisely predictable response behavior to the energy dissipation device on the one hand and, on the other, the sequence of events during energy dissipation.

In another (alternative) realization of the solution according to the invention, it is advantageously provided for the bearing block to comprise a conical ring connected at its coupling plane-side end section to the car body-side end section of the second bearing support part and which abuts against the inner surface of the transition section between the deformation tube section with the widened cross-sectional area and the section of the deformation tube located closer to the car body so as to thus realize the above-cited defined transmission of force in the deformation tube from the second bearing support part. The guide element is hereby furthermore advantageously connected by its coupling plane-side end section to the car body-side end section of the second bearing support part and its car body-side end section extends at least partly into the deformation tube section disposed closer to the car body which, prior to the energy dissipation device responding, exhibits a reduced inner diameter compared to the (widened) cross-section of the deformation tube section disposed closer to the coupling rod. The car body-side end section of the guide element thus abuts the inner surface of the deformation tube section with the reduced inner diameter.

The advantages achieved by the providing of this type of guide element configured as a separate component to the conical ring correspond substantially to the advantages as described above in conjunction with the guide element exhibiting a conical ring integrally formed with the guide element. In order to avoid repetition, reference is made at this point to the preceding remarks. Although the two-part design to the guide element and conical ring yields the additional advantage of being able to retrofit a conventional energy dissipation device, such as described above with reference to FIG. 1, and with which the bearing block is downstream of a deformation tube without the provision of an axial guide, with such a guide element. All that is necessary hereto is for the guide element to be disposed on the car body-side end section of the second bearing support part such that the coupling plane-side end section of the guide element is connected to the car body-side end section of the second bearing support part and that the car body-side end section of the guide element extends at least partly into the deformation tube section disposed closer to the car body having the not yet widened inner diameter prior to the response of the energy dissipation device. The car body-side end section of the guide element is thereby to position against the inner surface of this deformation tube section with the reduced inner diameter.

With the latter-cited realization of the solution according to the invention in which the conical ring and the guide element are each configured as separate components, it is preferably respectively provided for the conical ring to positively engage by its coupling plane-side end section on the one hand and the guide element to positively engage by its coupling plane-side end section on the other with the car body-side end section of the second bearing support part. Such a positive connection allows a particularly easily realized and yet effective way to realize the most reliable and complete transmission of force possible between the second bearing support part and the respective component of the energy dissipation device, in particular the conical ring on the one hand and the guide element on the other. It is of course also conceivable here to use a bolted joint, etc., to connect the conical ring and/or the guide element to the car body-side end section of the second bearing support part. It is generally preferred for there to be no play possible between the guide element and the second bearing support part on the one hand and the conical ring and the second bearing support part on the other in order to shorten and define the response behavior of the energy dissipation device and especially also enable a predefinable sequence of events during energy dissipation.

In one particularly preferred embodiment of the latter-cited realization in which the guide element on the one hand and the conical ring on the other are each configured as separate components, it is conceivable for the guide element and the second bearing support part to be formed integrally, whereby the number of individual components to the inventive coupling assembly can be reduced, which is of advantage particularly as regards the simplified assembling of the energy dissipation device. With respect to the first bearing support part, it is preferably provided for same to be mounted to the associated car body by means of a bolted joint. Additionally or alternatively hereto, it is however also conceivable for the first bearing support part to be attachable to the car body by means of a positive connection. These are possible realizations for fixedly connecting the first bearing support part to e.g. the undercarriage of the associated car body. However, other embodiments are of course also conceivable.

One preferred realization of the first bearing support part provides for same to comprise at least two parallel spaced rails which can be bolted for example to a fixing flange on the undercarriage of the car body. These at least two rails of the first bearing support part extending parallel to one another are to be configured such that they create an opening which, upon a crash, meaning when the second bearing support part is displaced toward the car body relative the first bearing support part and the deformation tube together with the guide element upon response of the energy dissipation device, permits the passage of the car body-side end section of the interface with the second bearing support part affixed thereto. The solution proposed here constitutes an especially simple to realize embodiment of the first bearing support part consisting of parallel spaced preferably perpendicular rails bolted to the undercarriage. However, other embodiments are of course also conceivable.

Lastly, particularly preferred with the proposed inventive solution is for the second bearing support part to be braced preferably without play between the first bearing support part and the deformation tube on the one hand and, on the other, the deformation tube to be designed such that upon the exceeding of a predefinable operating load for the coupling assembly, the second bearing support part is moved toward the car body relative the first bearing support part and thus the section of the deformation tube disposed closer to the car body, which prior to the energy dissipation device responding exhibits a non-widened cross-section, thereby being plastically deformed by cross-sectional widening. It is thus possible for the energy dissipation device to reliably protect the coupling assembly from excessive impacts, etc., doing so by having the energy dissipation device's response behavior on the one hand and the maximum energy dissipation on the other be adapted to the coupling assembly's operating load.

The energy dissipation device according to the invention is particularly preferably suited as a shock absorber in a coupling assembly of a multi-member vehicle, whereby the coupling assembly comprises a coupling rod for transferring tractive and impact forces, and whereby the interface of the energy dissipation device preferably oriented to the coupling plane comprises a vertically-extending pivot pin, by means of which the car body-side end section of the coupling rod is articulated to the second bearing support part so as to be pivotable in the horizontal plane. This use of the inventive energy dissipation device thus provides a coupling assembly with an energy-dissipating element in which maximum energy dissipation can be realized in a predeterminable sequence of events upon a crash. In particular, a coupling assembly is specified with which in the event of a crash; i.e. upon tho exceeding of the coupling assembly's operating load, at least a portion of the resultant impact energy can be dissipated according to a defined and predeterminable sequence of events on the one hand and, on the other, the energy-dissipating element utilized for this purpose requires the smallest possible installation space in the undercarriage of the car body.

On the other hand, utilizing the inventive energy dissipation device in a side buffer of a multi-member vehicle is likewise preferred, whereby the side buffer comprises a baffle area to conduct impact forces to the energy dissipation device, and whereby the interface of the energy dissipation device preferably oriented to the coupling plane is preferably fixedly connected to the baffle area of the side buffer. This thereby yields energy dissipation for a side buffer which in the event of a crash; i.e. upon the exceeding of for example a coupling assembly's operating load, the resulting impact energy in particular can be at least partly dispelled in the energy dissipation device according to a defined and predeterminable sequence of events.

The following will make reference to the included figures in describing preferred embodiments of the solution according to the invention in greater detail.

Shown are:

FIG. 1 a partly sectional side view of a bearing block known from the prior art having a downstream energy dissipation device;

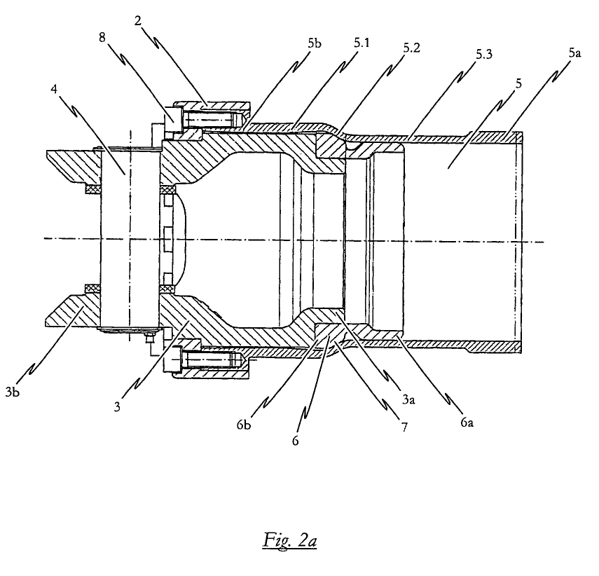

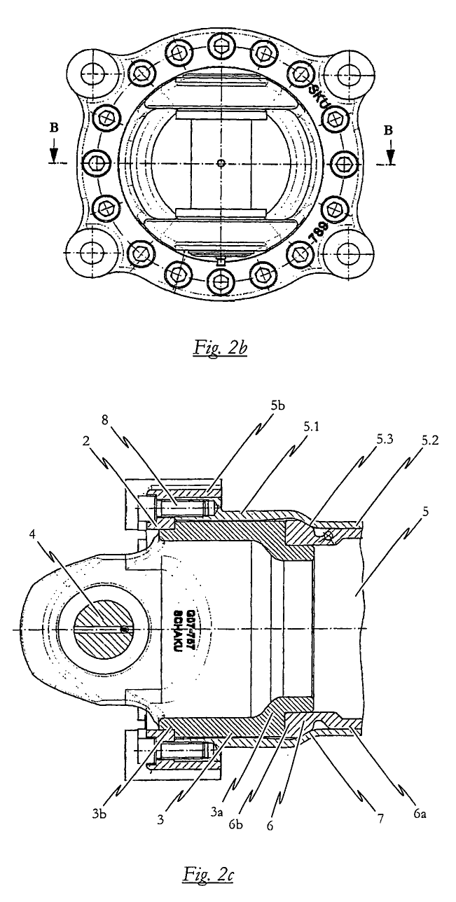

FIG. 2a a sectional side view of a first preferred embodiment of the energy dissipation device according to the invention as utilized in a coupling assembly;

FIG. 2b a rear view of the energy-dissipating element (deformation tube) utilized in the embodiment according to FIG. 2a;

FIG. 2c a side view along the B-B line indicated in FIG. 2b through the bearing block utilized in the first embodiment of the inventive energy dissipation device having the downstream energy-dissipating element;

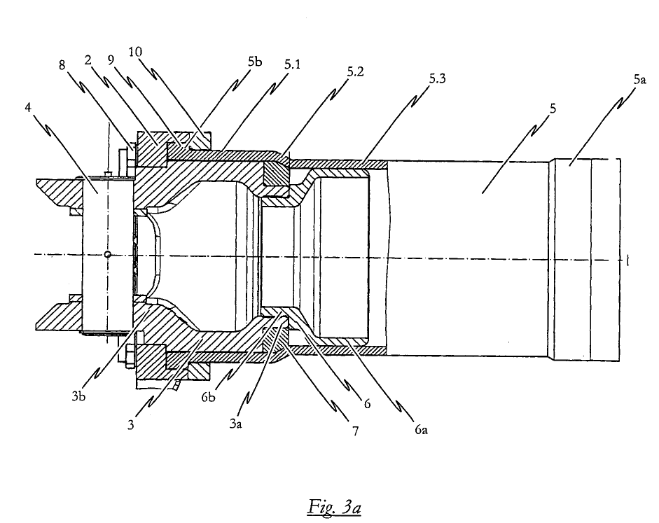

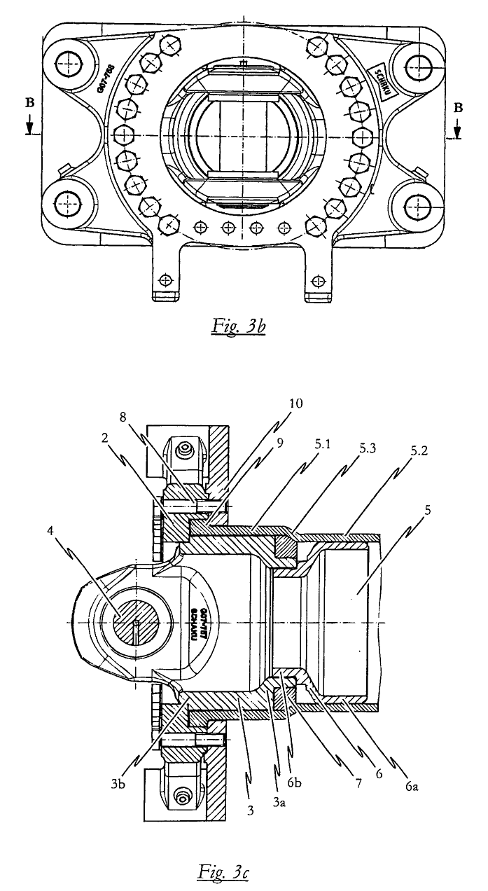

FIG. 3a a sectional side view of a second preferred embodiment of the energy dissipation device according to the invention as utilized in a coupling assembly;

FIG. 3b a rear view of the energy-dissipating element (deformation tube) utilized in the embodiment according to FIG. 3a; and

FIG. 3c a side view along the B-B line indicated in FIG. 3b through the bearing block utilized in the second embodiment of the inventive energy dissipation device having the downstream energy-dissipating element.

FIG. 1 shows a partly sectional side view of a bearing block having an energy dissipation device as is customarily utilized as a shock absorber in coupling assemblies in accordance with the prior art. As indicated above, the solution depicted in FIG. 1 is characterized by the energy dissipation device requiring a relatively small installation space, since after the energy dissipation device has responded, the deformation tube plastically deforms by cross-sectional widening and is thus not ejected from the energy dissipation device, for example by a nozzle plate. In the known solution as depicted in the FIG. 1 example, there is however the risk that upon the energy dissipation device responding, the second bearing support part 300 with the conical ring 700 will wedge in the deformation tube 500 such that the function of destructive energy absorption is no longer reliably provided in a defined and in particular predeterminable sequence of events.

FIG. 2a shows a first preferred embodiment of the energy dissipation device according to the invention as used in a coupling assembly in a sectional side view. A rear view of the energy dissipation device shown in FIG. 2a is shown in FIG. 2b. FIG. 2c shows a side view along the B-B line indicated in FIG. 2b through the bearing block as utilized in the second embodiment of the inventive energy dissipation device having the downstream energy-dissipating element in accordance with FIG. 2a.

The coupling assembly in which the first preferred embodiment of the energy dissipation device is utilized essentially comprises a coupling rod not explicitly shown in the figures to transmit tractive and impact forces and a bearing block affixable to a car body of a multi-member vehicle. Specifically, the bearing block consists of a first bearing support part 2 fixedly mountable to a car body of a multi-member vehicle and a second bearing support part 3 coupled to the car body-side end section of the coupling rod by means of a pivot pin 4. The pivot pin 4 hereby represents the interface through which the impact forces transferred for example from an adjacent car body can be transmitted through the coupling rod into the second bearing support part 3.

The first bearing support part 2 which, as depicted, can consist of two rails extending substantially parallel to one another, can be fixedly mounted to the car body via a bolted joint 8. In contrast, the second bearing support part 3 is braced without play between a projecting element 10 of the first bearing support part 2 and a deformation tube 5 which is situated downstream the bearing block for absorbing energy.

In detail, the deformation tube 5 comprises hereto a section 5.1 fixedly connected to the first bearing support part 2 on its coupling rod-side or coupling plane-side end section 5b, said section 5.1 having a widened cross-sectional area in comparison to a section 5.2 of the deformation tube 5 disposed closer to the car body. The coupling rod-side or coupling plane-side deformation tube section 5b; i.e. that section of the deformation tube 5 exhibiting a widened cross-sectional area, can be fixedly connected to the first bearing support part 2 via the above-cited bolted joint 8, as indicated in FIG. 2a.

The pivot pin 4 is provided on the coupling rod-side or coupling plane-side end section 3b of the second bearing support part 3 as the interface for conducting impact forces to the energy dissipation device; the car body-side end section of the (not explicitly shown) coupling rod being articulated to the bearing block at said pivot pin 4 so as to be pivotable in the horizontal plane.

The car body-side end section 3a of the second bearing support part 3 is in contrast braced without play between the above-cited projecting element 10 of the first bearing support part 2 and the section 5.2 of the deformation tube 5 disposed closer to the car body; i.e. the deformation tube section with the reduced cross-sectional area prior to the response of the energy dissipation device compared to the cross-sectional area of the coupling rod-side deformation tube section 5b fixedly connected to the first bearing support part 2.

Specifically, a guide element 6 is hereby provided on the car body-side end section 3a of the second bearing support part 3 which comprises a conical ring 7 formed integrally with the guide element 6. The coupling rod-side end section 6b of guide element 6 is connected to the car body-side end section 3a of the second bearing support part 3 by positive engagement, whereby the car body-side end section 6a of guide element 6 extends at least partly into the deformation tube section 5.2 with the unwidened cross-sectional area disposed closer to the car body and abuts against the inner surface of this deformation tube section 5.2.

The conical ring 7 formed integrally with the guide element 6 in the embodiment according to FIGS. 2a to 2c on the other hand abuts against the inner surface of the transition section 5.3 between the deformation tube 5.1 having the widened cross-sectional area and the deformation tube section 5.2 disposed closer to the car body.

The car body-side end section 6a of guide element 6 which extends in the unwidened deformation tube section 5.2 and positions against the inner surface of this deformation tube section 5.2 yields an axial guidance with which, upon the energy dissipation device responding, the second bearing support part 2 is guided in a directed and defined manner toward the car body relative the first bearing support part 2 and the deformation tube 5 along with the simultaneous cross-section widening of the deformation tube section 5.2 positioned closer to the car body.

FIGS. 3a to 3c depict a variant of the bearing block comprising the energy dissipation device described above with reference to FIGS. 2a to 2c, whereby this preferred alternative is utilized in a second embodiment of the inventive energy dissipation device. Specifically, FIG. 3a shows a sectional side view of a second preferred embodiment of the energy dissipation device according to the invention as utilized in a coupling assembly. A rear view of the energy dissipation device utilized in the embodiment according to FIG. 3a is shown in FIG. 3b. FIG. 3c shows a sectional view along the B-B line indicated in FIG. 3b through the bearing block utilized in the second embodiment of the energy dissipation device according to the invention having the downstream energy-dissipating element.

As can especially be seen from FIGS. 3a and 3c, the second embodiment of the inventive energy dissipation device firstly differs from the first embodiment described above with reference to FIGS. 2a to 2c in that the coupling rod-side end section 5b of the deformation tube 5 is not fixedly connected to the first bearing support part 2 by means of the bolted joint 8, but rather via a positive connection. This positive connection is formed by a radially-projecting element 9 on the coupling rod-side end section 5b of the deformation tube 5 together with the bearing support part 2 as well as an element 10.

Additionally differing from the first embodiment is the realization of guide element 6 in the bearing block with the downstream energy-dissipating element utilized in the second preferred embodiment of the inventive energy dissipation device. As can especially be seen from FIGS. 3a and 3c, a conical ring 7 is provided in the second embodiment, which is fixedly connected at its coupling rod-side end section 7b to the car body-side end section 3a of the second bearing support part 3 by means of positive engagement, and which positions against the inner surface of the transition section 5.3 between the deformation tube section 5.1 having the widened cross-sectional area and the deformation tube section 5.2 disposed closer to the car body. Additionally to the conical ring 7, the second embodiment comprises a guide element 6 configured separately from the conical ring 7, which is likewise preferably connected at its coupling rod-side end section 6b to the car body-side end section 3a of the second bearing support part 3 via positive engagement, whereby the car body-side end section 6a of guide element 6 extends at least partly into the deformation tube section 5.2 disposed closer to the car body and positions against the inner surface of this deformation tube section 5.2.

Since the conical ring 7 on the one hand and the guide element 6 on the other are configured as separate components in the second embodiment, the guide element 6 depicted in FIGS. 3a and 3c is particularly suited for retrofitting an existing solution, as depicted for example in FIG. 1. It is accordingly possible to only incorporate the guide element 6 according to FIG. 3a in the solution shown in FIG. 1 in order to provide the energy dissipation device with the functionality of axial guidance upon the operating load of the coupling assembly being exceeded.

The design of the invention is not limited to the embodiments described with reference to the figures. In fact, the individual features described herein can be realized in any combination of one another desired. In particular, it is for example also conceivable for the energy dissipation device to be utilized in a side buffer of a multi-member vehicle, whereby the side buffer comprises a baffle area for conducting impact forces to the energy dissipation device, and whereby the energy dissipation device interface preferably oriented to the coupling plane is preferably fixedly connected to the baffle area of the side buffer.

### LIST OF REFERENCE NUMERALS

2 first bearing support part
3 second bearing support part
3a car body-side end section of the second bearing support part
3b coupling rod-side end section of the second bearing support part
4 pivot pin
5 deformation tube
5a car body-side end section of the deformation tube
5b coupling rod-side end section of the deformation tube
5.1 deformation tube section of widened cross-sectional area
5.2 deformation tube section of unwidened cross-sectional area
5.3 transition section of the deformation tube
6 guide element
6a car body-side end section of the guide element
6b coupling rod-side end section of the guide element
7 conical ring
7a car body-side end section of the conical ring
7b coupling rod-side end section of the conical ring
8 bolted joint
9 projecting element on the coupling rod-side end section of the deformation tube of the first bearing support part
10 projecting element on the first bearing support part

1. An energy dissipation device for a coupling assembly, for a close coupler or for a side buffer of a multi-member vehicle, having a bearing block mountable to a car body which comprises an interface preferably oriented to the coupling plane by means of which the impact forces transmitted from an adjacent car body can be conducted to the bearing block, and a deformation tube positioned against the bearing block, wherein the bearing block comprises a first bearing support part fixedly mountable to a car body of the multi-member vehicle and a second bearing support part connected to the car body-side end section of the interface;
wherein the deformation tube comprises a section fixedly connected to the first bearing support part at its coupling plane-side end section which exhibits a widened cross-section compared to a section of the deformation tube located closer to the car body;
wherein the car body-side end section of the second bearing support part is braced between the first bearing support part and the section of the deformation tube positioned closer to the car body; and
wherein the bearing block further comprises a guide element, its coupling plane-side end section connected to the car body-side end section of the second bearing support part, and its car body-side end section extending at least partly into the section of the deformation tube disposed closer to the car body and abutting the inner surface of said deformation tube section.

2. The energy dissipation device according to claim 1, wherein
the guide element of the bearing block comprises a conical ring integrally formed with said guide element, its coupling plane-side end section connected to the car body-side end section of the second bearing support part and its car body-side end section extending at least partly into the section of the deformation tube disposed closer to the car body and abutting the inner surface of said deformation tube section.

3. The energy dissipation device according to claim 2, wherein
the coupling plane-side end section of the conical ring is in positive engagement with the car body-side end section of the second bearing support part.

4. The energy dissipation device according to claim 2, wherein
the coupling plane-side end section of the conical ring is fixedly connected to the car body-side end section of the second bearing support part by means of a force-fit connection.

5. The energy dissipation device according to claim 3, wherein
the coupling plane-side end section of the conical ring is fixedly connected to the car body-side end section of the second bearing support part by means of a force-fit connection.

6. The energy dissipation device claim 2, wherein
the conical ring abuts against the inner surface of the transition section between the deformation tube section of widened cross-section and the deformation tube section situated closer to the car body.

7. The energy dissipation device according to claim 3, wherein
the conical ring abuts against the inner surface of the transition section between the deformation tube section of widened cross-section and the deformation tube section situated closer to the car body.

8. The energy dissipation device according to claim 4, wherein
the conical ring abuts against the inner surface of the transition section between the deformation tube section of widened cross-section and the deformation tube section situated closer to the car body.

9. The energy dissipation device according to claim 1, wherein
the bearing block further comprises a conical ring which is connected to the car body-side end section of the second bearing support part on its coupling plane-side end section, and which abuts against the inner surface of the transition section between the deformation tube section of widened cross-section and the deformation tube section situated closer to the car body, and wherein the guide element is connected to the car body-side end section of the second bearing support part on its coupling plane-side end section and its car body-side end section extends at least partly into the section of the deformation tube disposed closer to the car body and abuts against the inner surface of said deformation tube section.

10. The energy dissipation device according to claim 9, wherein
the conical ring on the one hand positively engages on its coupling plane-side end section with the car body-side end section of the second bearing support part and the guide element on the other hand positively engages on its coupling plane-side end section with the car body-side end section of the second bearing support part respectively.

11. The energy dissipation device according to claim 9, wherein
the guide element and the second bearing support part are of integral configuration.

12. The energy dissipation device according to claim 10, wherein
the guide element and the second bearing support part are of integral configuration.

13. The energy dissipation device according to claim 2, wherein
the second bearing support part is braced without play between the first bearing support part and the deformation tube section positioned closer to the car body via the conical ring.

14. The energy dissipation device according to claim 1, wherein
the first bearing support part is mountable to the car body by means of a bolted joint.

15. The energy dissipation device according to claim 1, wherein
the first bearing support part is mountable to the car body by means of a positive connection.

16. The energy dissipation device according to claim 1, wherein
the first bearing support part comprises two rails extending substantially parallel to one another which can be fixedly screwed to the car body.

17. The energy dissipation device according to claim 1, wherein
the second bearing support part is braced between the first bearing support part and the deformation tube on the one hand, and the deformation tube is designed on the other such that upon the energy dissipation device exceeding a predefinable operating load, the second bearing support part is moved toward the car body relative the first bearing support part and thus the section of the deformation tube disposed closer to the car body is plastically deformed by cross-sectional widening.

18. Use of the energy dissipation device according to any one of claims 1 to 17 in a coupling assembly of a multi-member vehicle, wherein the coupling assembly comprises a coupling rod for transferring tractive and impact forces, and wherein the interface of the energy dissipation device preferably oriented to the coupling plane comprises a vertically-extending pivot pin, by means of which the car body-side end section of the coupling rod is articulated to the second bearing support part so as to be pivotable in the horizontal plane.

19. Use of the energy dissipation device according to any one of claims 1 to 17 in a side buffer of a multi-member vehicle, wherein the side buffer comprises a baffle area to conduct impact forces to the energy dissipation device, and wherein the interface of the energy dissipation device preferably oriented to the coupling plane is preferably fixedly connected to the baffle area of the side buffer.
